(19) United States
(12) Patent Application Publication
(10) Pub. No.: US 2026/0062209 A1
(43) Pub. Date: Mar. 5, 2026

(54) Waste disposal device for refuse, particularly for personal hygiene materials and products

(71) Applicant: CTP Innovations B.V., SON EN BREUGEL (NL)

(72) Inventor: Cornelis Paul Antonius PHIJFFER, SON EN BREUGEL (NL)

(21) Appl. No.: 19/314,135

(22) Filed: Aug. 29, 2025

(30) Foreign Application Priority Data
Aug. 30, 2024 (EP) 24197715.6

(51) Int. Cl. B65F 1/16; B65F 1/06

(52) U.S. Cl. CPC B65F 1/1607; B65F 1/06; B65F 2001/1676; B65F 2210/167; B65F 2220/1066; B65F 2240/164

(57) ABSTRACT

The present invention relates to a waste disposal device for refuse, comprising a container having a container opening and closing means that are positioned near to the container opening for substantially closing the container opening in such a way that odour release is prevented. The closing means comprising a drum housing comprising a drum opening and housing a drum body, wherein the drum body is pivotable between an insertion position for placing refuse in the waste disposal device and a transit position for aligning the refuse with the drum opening. The drum opening further comprising a flexible sealing member extending about the edge of the drum opening for that part that is closely connected to the external surface of the drum body, wherein the flexible sealing member having upwardly facing raised sealing portions in a direction away from the bottom of the container, that are in contact with the external surface of the drum body or wherein the flexible sealing member comprises two separated flexible sealing parts.

### TECHNICAL FIELD

The present invention relates to a waste disposal device for refuse, in particular for personal hygiene materials and products, such as diapers, training pants, sanitary napkins, adult incontinence, female hygiene products, such as tampons and pads, and the like.

### BACKGROUND

Waste disposal devices are generally known. Various waste disposal devices for personal hygiene materials and products are commercially available, including (adult) diaper disposal pails. A conventional diaper pail typically includes a pail portion which holds a disposal bag, and a receptacle assembly mounted on top of the pail configured to receive the soiled diaper and to transfer the soiled diaper into the disposal bag while minimizing the release of odour from previously disposed diapers already within the disposal bag.

Various receptacle assemblies within the prior art have included rotating drums contained within a housing having an opening communicating with the internal disposal bag. The drum has an opening to receive the soiled diaper. To dispose of the diaper, the drum is rotated to align the drum opening with the top opening in the housing. Once the diaper is received into the opening in the drum, the drum is rotated to align the drum opening with the lower opening and allow the diaper to drop into the disposal bag. While these types of diaper pails have had relatively good commercial success, it has been found that the existing designs still do not effectively prevent the escape of odours. Providing a seal around the housing and between the upper receptacle assembly and the lower pail is not a difficult task, as these components do not move relative to each other during normal use and the seals are loaded only in compression, but, this arrangement does require multiple seals and additional related parts as well as additional cost and complexity. On the other hand, the provision of a substantially airtight seal between moving components is not as simple, and the most difficult place to provide a seal is between the moving surfaces of the drum and the lower half of the drum housing.

In United States patent application published under number US 2010/0301050 A1 an attempt was made to provide a diaper pail having an improved plastic annular seal, comprising an outer radial part and an inner radial part that are connected to the drum housing, and having a movable part extending between the outer and inner radial part. Although the diaper pail disclosed in US 2010/0301050 A1 provided improved results, it is believed that the odour control can still be improved.

In addition to US 2010/0301050 A1 the present inventor attempted to provide a diaper pail with improved odour control. Such diaper pail is described in International patent application published under number WO 2014/035249 A1 providing a diaper pail having an improved plastic annular seal, comprising an outer radial part connected to the drum housing and a free inner radial part. The diaper pail disclosed in WO 2014/035249 A1 provided further improved results compared to the diaper pail disclosed in US 2010/0301050 A1. However, it is still believed that the control of odour could be further improved without compromising on the efficient and user-friendly way of disposing personal hygiene materials and products.

### DESCRIPTION OF THE INVENTION

In order to provide a waste disposal device for refuse, in particular for personal hygiene materials and products, such as diapers, training pants, sanitary napkins, adult incontinence and the like, that has a further improved control of odour without compromising on the efficient and user-friendly way of disposing personal hygiene materials and products, the present invention provides hereto a waste disposal device for refuse comprising a container having a bottom and a circumferential wall, wherein the container has a container opening on the end remote from the bottom, wherein the waste disposal device is provided with closing means that are positioned near to the container opening for substantially closing the container opening in such a way that odour release is prevented. The closing means comprise:
a drum housing provided in the internal part of the waste disposal device, said drum housing having a drum opening facing the interior of the container;
a drum body having an external surface that is at least partially closely connected to an inner surface of the drum housing, wherein the drum body has a transport container for the refuse, said transport container extending inwardly from the external surface thereof, wherein the drum body is pivotable between an insertion position wherein refuse is placeable in the transport container, and a transit position wherein the transport container is aligned with the drum opening;
a flexible sealing member extending about the edge of the drum opening of the drum housing for that part that is closely connected to the external surface of the drum body, wherein the flexible sealing member comprises a connection part that is located outwards, and that is connected to the drum housing, wherein the flexible sealing member comprises a sealing part connected to the connection part, which sealing part extends inward from the connection part and which may be brought into sealing contact with the external surface of the drum body for sealing the container opening in a substantially odour-free manner, and wherein the inner end of the sealing part that is remote from the connection part is free from any connection to the drum housing such that a freely movable free end of the flexible sealing member is formed.

The waste disposal device of the present invention further comprises a cover configured and arranged to be received on the container, wherein the cover comprises a cover opening for supplying the refuse to the container, wherein the drum housing, when the cover is placed on the container, at least partially encloses the drum body, and wherein, in the insertion position, the transport container is aligned with the cover opening.

According to the invention, the sealing part of the flexible sealing member is provided with two or more upwardly facing raised sealing portions in a direction away from the bottom of the container, said sealing portions are in contact with the external surface of the drum body. It was found that by providing a flexible sealing member of which the sealing part is provided with two or more upwardly facing raised sealing portions, at least a double seal is provided between the external surface of the drum body and the edge of the drum opening of the drum housing enclosing the container opening. By providing an at least double, triple or even quadruple seal by providing a sealing part having two, three or even four upwardly facing raised sealing portions, respectively, a more controlled retainment of odour within the waste disposal device is provided for by using a single flexible sealing member. Instead of providing two or more flexible sealing members, by providing one single flexible sealing member that is capable of providing at least two sealing barriers, the handling of the drum body, e.g., the force needed by the user to rotate the drum body, is still user-friendly and efficient. By providing a flexible sealing member having two or more upwardly facing raised sealing portions the contact surface between the drum body and the sealing part of the flexible sealing member is reduced, causing a reduction in friction. As such, although the control of odour is further improved by providing at least two sealing barriers, the force to be applied by the user for rotating the drum body is reduced.

It is noted that the drum body of the waste disposal device may have a pill-shaped, spherical, or cylindrical shape. The flexible sealing member typically extends about the edge of the drum opening of the drum housing, at least that part of the edge of the drum opening of the drum housing that is closely connected to the external surface of the drum body. In other words, the flexible sealing member does not necessarily extend about the full length of the edge of the drum opening of the drum housing. Although, in most cases the flexible sealing member extends about the circumferential edge of the drum opening, thus providing an annular flexible sealing member, in alternative embodiments, the flexible sealing member may extend about opposite edges of the drum opening or the like.

In this respect it is noted that the waste disposal device of the present invention is suitable for the deposition of refuse, in particular personal hygiene materials and products, such as diapers, training pants, sanitary napkins, adult incontinence, female hygiene products, such as tampons and pads, and the like. In other words, the waste disposal device will not only be operated by young parents deposing diapers of their babies, but also by elderly people with less strength to operate a drum body with more resistance due to an improved seal. In addition, the waste disposal device of the present invention may also be used in medical care facilities, such as hospitals and nursing homes. As such facilities require different dimensions of the waste disposal device to deposit a higher volume of personal hygiene materials and products, the improved sealing of the waste disposal device of the present invention without increasing of the friction between the drum body and the flexible sealing member is highly appreciated in order to prevent work-related physical complaints (such as muscle pain and repetitive strain injuries).

In order to further improve the ease of use of the waste disposal device of the present invention, in another embodiment of the present invention, a waste disposal device is provided wherein the drum body of the waste disposal device has a cylindrical shape comprising two parallel circular bases joined by a curved surface which curved surface defines the external surface of the drum body. In this embodiment, the flexible sealing member optionally comprises two separated flexible sealing parts, wherein one flexible sealing part extends about the edge of the drum opening of the drum housing opposite the edge of the drum opening of the drum housing the other flexible sealing part extends. Both flexible sealing parts are in contact with the external surface of the drum body. It was found that by providing a waste disposal device having a cylindrical drum body, a further improved handling of the waste disposal device is provided for compared to a waste disposal device having a pill-shaped or spherical shape, wherein the flexible sealing member extends about the circumferential edge of the drum opening of the drum housing. A further reduction in friction is provided by a waste disposal device wherein the drum body has a cylindrical shape. Although, due to the construction of the drum body having a cylindrical shape, the retainment of odours is controlled in a more controlled way, the retainment of odours may be further controlled by providing flexible sealing members similar to the flexible sealing members used in the waste disposal device having a pill-shaped or spherical shape as described above. In other words, the flexible sealing members of such waste disposal device may have a sealing part provided with two or more upwardly facing raised sealing portions in a direction away from the bottom of the container, said sealing portions are in contact with the external surface (i.e., the curved surface) of the drum body.

In addition, in order to further improve the retainment of odour in the waste disposal device of the present invention comprising a drum body having a cylindrical shape, each of the external surfaces of the two parallel circular bases of the drum body that are connected to the drum housing may be provided with a sealing ring for sealing a gap formed between the external surface of the circular base and the internal surface of the drum housing. It is noted that such sealing ring is preferably selected from a material that does not cause an increased friction between the external surface of the circular base and the internal surface of the drum housing, in order to avoid a sudden increase in force needed to rotate the drum body. However, it is further noted that due to the cylindrical shape of the drum body, different to the spherical shape of the drum body, the choice of suitable and available materials is greater due to a lower normal force for the cylindrically shaped drum body compared to the spherically shaped drum body.

Given the above, it is noted that the upwardly facing raised sealing portions of the sealing part of the flexible sealing member of the present invention may be selected from the group consisting of ridges, ribbons, strips and combinations thereof. Preferably, the upwardly facing raised sealing portions are elongated raised portions that run in the longitudinal direction of the flexible sealing member in order to provide for a sealing between the external surface of the drum body and the flexible sealing member. In a preferred embodiment, the upwardly facing raised sealing portions of the sealing part of the flexible sealing member are formed by a sealing part having a sine waveform, triangle waveform, sawtooth waveform or composite waveforms combining different waveforms. In a more preferred embodiment of the present invention the waste disposal device having a flexible sealing member comprising a sealing part having a sine waveform. Ideally, such sine waveform comprises three waves in order to provide optimal sealing properties without reducing the ease of use in rotating the drum body of the waste disposal device of the present invention.

The inner end of the flexible sealing member, i.e., the free end of the sealing part of the flexible sealing member, may extend upwardly in a direction away from the bottom of the container, and is in contact with the outer surface of the drum body. By providing a flexible sealing member wherein the inner end extends upwardly in a direction away from the bottom of the container a further improved sealing of the waste disposal device of the present invention is provided.

In an embodiment which has excellent sealing characteristics, the connection part is movably connected to the drum housing. The connection part is preferably movable in an axial direction. In one embodiment the connection part is movable in substantially the axial direction only. Due to the fact that the connection part is movably connected to the drum housing, preferably in the axial direction, the flexible sealing member as a whole is also movable relative to the drum housing, preferably in the axial direction. This highly improves the sealing characteristics of the flexible sealing member, especially when rotating the drum body, since the flexible sealing member may adjust its position by deformation during rotation of the drum body.

In a specific embodiment, the connection part is slidably received in a groove of the drum housing, thus enabling movement of the connection part, and the flexible sealing member as a whole. An additional advantage of this embodiment is that there is no need for holes in the drum housing for attaching the connection part. Thus, the drum housing may be manufactured as a continuous surface without holes, yielding an additional barrier for odour release.

In another embodiment, the connection part, and thus the flexible sealing member of the present invention, is an integral part of the drum housing. By providing a waste disposal device wherein the flexible sealing member is an integral part of the drum housing, the production efficiency is increased.

In an embodiment, the sealing part extends radially inward from the connection part, towards the bottom of the container. Preferably, the sealing part extends at an angle of approximately 70-90 degrees with respect to the connection part. The angle is preferably adapted to the dimensions of the drum body. In particular, the sealing part may extend at an angle that substantially forms a tangent line of the drum body.

In an embodiment, the sealing part then continues to extend further radially inward, in a direction away (i.e., upward) from the bottom of the container. In that sense, the sealing part comprises an outer part that is connected to the connection part and that extends radially inward from the connection part, towards the bottom of the container, as well as an inner part connected to the outer part, which inner part extends further radially inward, in a direction away from the bottom of the container. The outer part is substantially transversely directed to the external surface of the drum body. Due to the fact that this part is flexible, it is able to deform in such a way that it closely follows the contour of the external surface of the drum body, such that any irregularities that occur in the external surface, are also correctly sealed.

The drum body may be slidably connected to the drum housing. By providing the drum body being slidably connected to the drum housing, the drum body is pressed, under the influence of gravity, on the flexible sealing member. In an embodiment of the present invention, the drum body may be pressed, under the influence of gravity, on the flexible sealing member in either the insertion position or the transit position. In a preferred embodiment, the slidable connection may be in such a way that in the insertion position the drum body is pressed, under the influence of gravity, on the flexible sealing member. In combination with the flexible sealing member according to the invention, in particular a flexible sealing member that is provided with upwardly facing raised sealing portions, this yields better sealing characteristics. In this respect, it is noted that the ‘default’ or ‘standby’ position of the waste disposal device is preferably a waste disposal device wherein the drum body is in its insertion position. It was observed that in case the waste disposal device is kept in its transit position after use (i.e., wherein the cover opening is covered by the external surface of the drum body), odours will enter the transport container and will be released when moving the drum body to its insertion position.

In order to avoid the waste disposal device to be kept in its transit position after use, the waste disposal device, and the drum housing in particular, may be provided with biasing means, such as a spring or elastic band, which biasing means are biased in case the drum body is moved into its transit position. By releasing the force applied onto the drum body by the user, the drum body will subsequently move into its insertion position under influence of the biased biasing means. Alternatively, the drum housing may be provided with electrical actuators, such as an electrical motor or the like, which configured to rotate the drum body. By using a sensor or the like, the electrical actuators may be activated to start a rotating motion. Ideally, the actuators are programmed to return to the insertion position of the drum body. It is further noted that by using the flexible sealing member of the present invention having improved sealing characteristics and, simultaneously, having a reduced friction with the external surface of the drum body, the force to be applied by the biasing means can be reduced or will result in prolonged battery life in case electrical actuators are used.

In a further embodiment, the waste device further comprises bag holder means for aligning a bag-like container with the drum opening.

The bag holder means may comprise a holder housing having a holder opening, wherein said holder housing is connected to the container, and wherein said holder opening is aligned with the drum opening. The bag may be retracted from the bag holder means by the user without the need of opening the cover first. In such way, the user is able to remove the bag from the waste disposal device in a constant odour-sealed way, i.e., odour-sealed by the cover over the waste disposal device and, subsequently, by the hand of the user closing the bag before removing the bag from the bag holder means from the closed cover.

The drum opening comprises in an embodiment a wall that extends from the drum opening towards the bottom of the container, wherein said wall engages the edge of the holder that is formed by the opening of the holder. The bag-like container is then positioned in between the wall and the edge of the holder.

In a further embodiment of the present invention, the waste disposal device comprises a container having a circumferential wall comprising at least two circumferential wall portions, which circumferential wall portions are configured such that they are telescopically slidable over each other. By providing a waste disposal device having telescopically slidable circumferential wall portions, not only transport of the waste disposal device is further facilitated by having waste disposal devices transported with a reduced volume, also the multifunctionality of the waste disposal device is further improved. By providing a waste disposal device that is able to adapt to different volumes, the usability, suitability and applicability of the waste disposal device is further increased. One could understand that only a low volume waste disposal device is required for a waste disposal device used in toilet facilities and washrooms. However, for the purpose of deposing, for example, diaper materials, a high volume waste disposal device is preferably required.

In this further embodiment, it is further noted that the at least two circumferential wall portions are moveable between a telescopically retracted position and a telescopically extended position. Optionally, the at least two circumferential wall portions are reversibly lockable relative to each other in the telescopically extended position. Such reversible lock may be provided by rotating the at least two circumferential wall portions relative to each other activating a bayonet mount or the like.

### EMBODIMENTS

Further features and advantages of the invention will become apparent as the description thereof proceeds when considered in connection with the accompanying illustrative drawings. In the drawings which illustrate the best mode presently contemplated for carrying out the present invention, wherein:

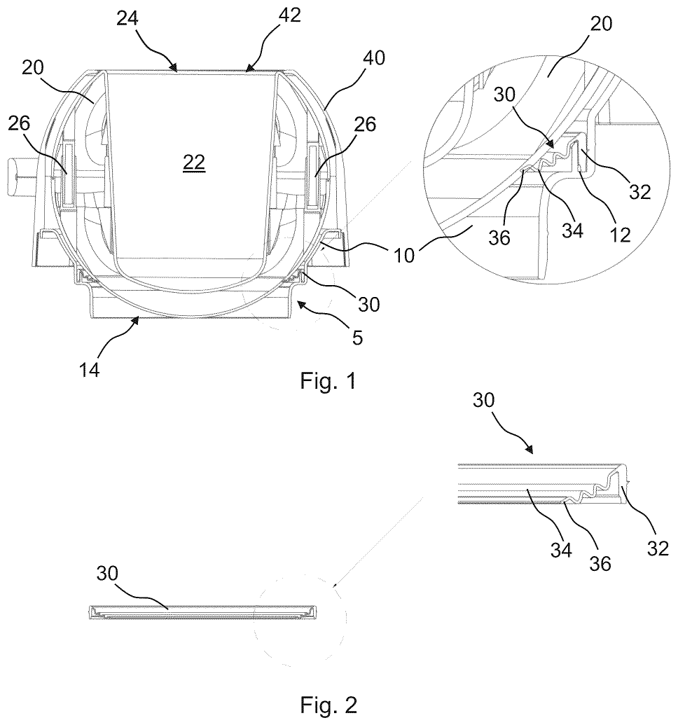

FIG. 1 depicts a cross section of the closing means according to an embodiment of the present invention;

FIG. 2 depicts a cross section of the flexible sealing member according to an embodiment of the present invention;

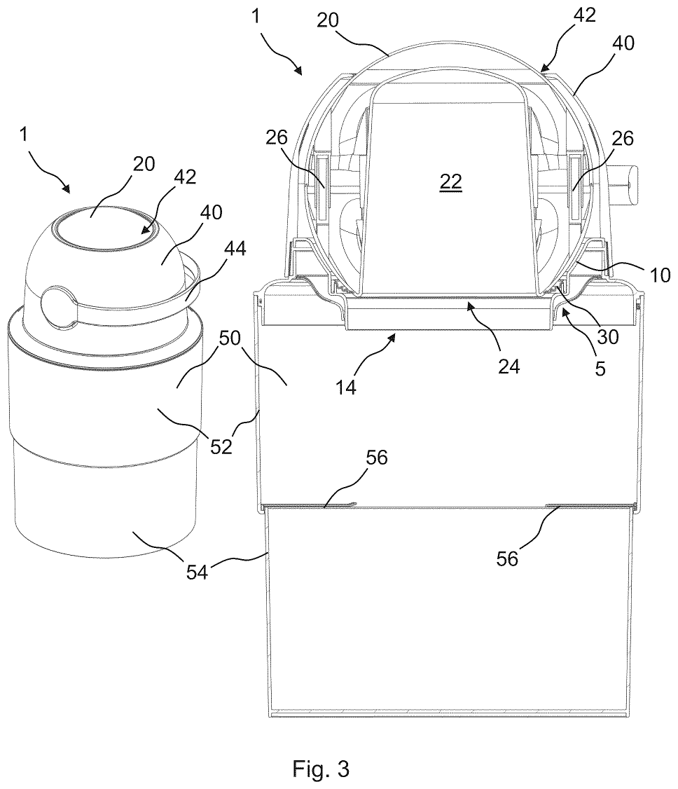

FIG. 3 depicts a cross section and a perspective view of the waste disposal device comprising the closing means according to the embodiment depicted in FIG. 1;

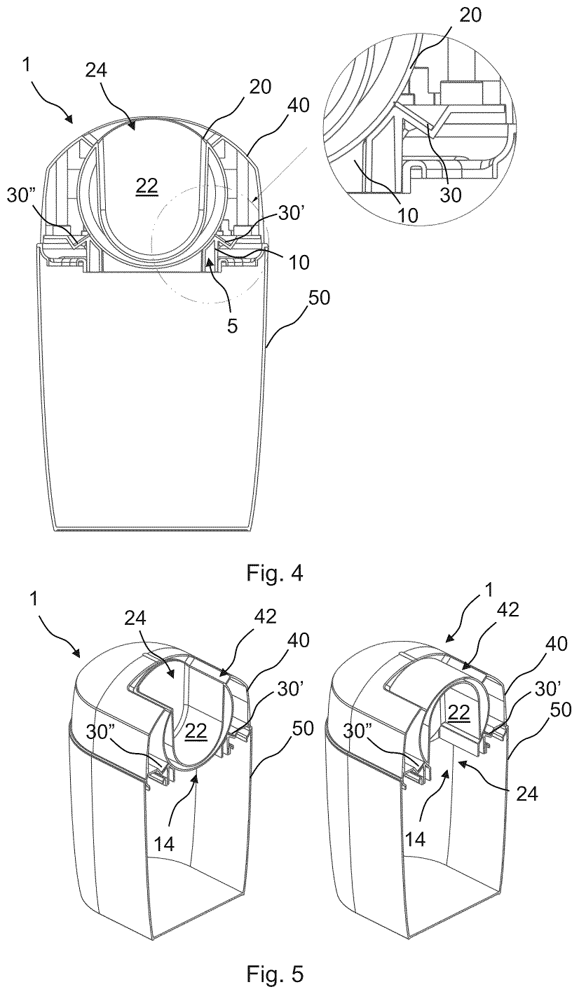

FIG. 4 depicts a cross section of the waste disposal device according to a further embodiment of the present invention;

FIG. 5 depicts a perspective cross sectional view of the waste disposal device of the same embodiment depicted in FIG. 4;

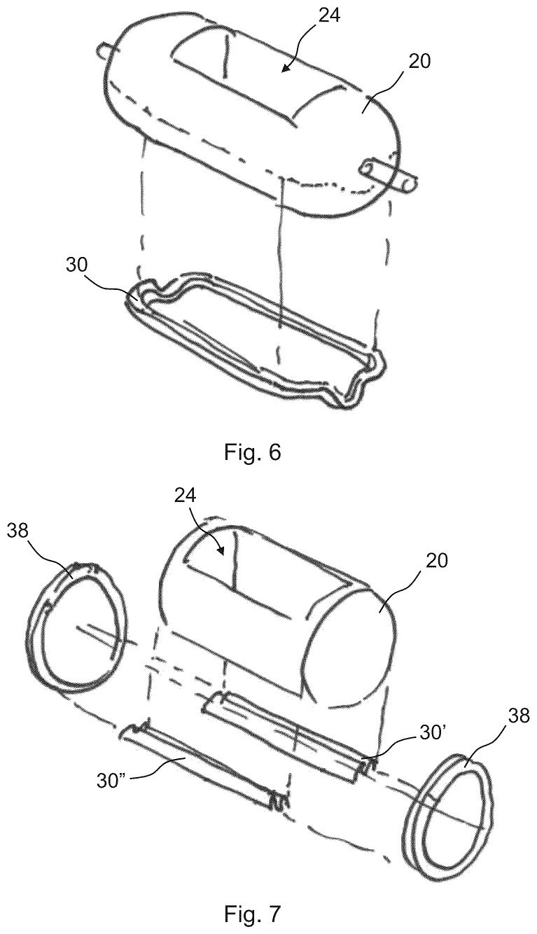

FIG. 6 depicts an exploded view of the flexible sealing member and the pill-shaped drum body according to another embodiment of the present invention; and

FIG. 7 depicts an exploded view of the flexible sealing members, sealing rings and drum body having a cylindrical shape.

FIG. 1 shows a cross section of the closing means 5 of an embodiment of the present invention, wherein the closing means 5 comprise a drum housing 10 and drum body 20 which closing means 5 further cooperate with a cover 40. The drum body 20 as shown in FIG. 1 has a spherical shape. The drum body 20 is enclosed by a circumferential flexible sealing member 30. The flexible sealing member 30 is received by the drum housing 10 in a circumferential groove 12 located at the edge of the drum opening 14 of the drum housing 10. The flexible sealing member 30 comprises a connection part 32 received by a circumferential groove 12 of the drum housing, such that the flexible sealing member 30 encloses the drum body 20 at the edge of the drum opening 14. The connection part 32 is connected to the sealing part 34. In FIG. 1 the sealing part 34 extends radially inward from the connection part 32, towards the bottom of a container (not shown). By providing a sealing part 34 that extends radially inward from the connection part 32, the contact of the sealing part 34 with the external surface of the drum body 20 is further improved. The sealing part 34 as shown in FIG. 1 is in the form of a sine waveform providing a double or triple sealing effect on the drum body 20. It is further noted that the inner end 36 of the flexible sealing member 30 is free from any connection to the drum housing 10 such that a freely movable free end 36 of the flexible sealing member 30 is formed.

FIG. 1 further shows the transport container 22 for refuse (not shown) of the drum body 20. In the configuration shown in FIG. 1, the drum body 20 is in its insertion position, i.e., the opening 24 of the transport container 22 is facing away from the drum opening 14 and aligned with the covering opening 42. The drum body 20 is further provided with rotation means 26 which rotation means 26 are connected to the drum housing 10.

FIG. 2 shows a cross section of the flexible sealing member 30 of an embodiment of the present invention. The flexible sealing member 30 comprises a connection part 32 configured to be received by the drum housing (not shown), e.g., by a circumferential groove (not shown). The connection part 32 is connected to the sealing part 34. In FIG. 2, the sealing part 34 extends radially inward from the connection part 32, towards the bottom of a container (not shown). Further, as shown in FIG. 2 the flexible sealing member 30 is designed in the form of a sine waveform.

FIG. 3 shows a perspective view of the waste disposal device 1 comprising a cover 40 comprising a cover opening 42. The waste disposal device 1 further depicts the drum body 20 positioned in its transit position. In addition, the container 50 of the waste disposal device 1 is shown including two circumferential wall portions 52, 54. The two circumferential wall portions 52, 54 are telescopically movable relative to each other. Further the perspective view of FIG. 3 shows the handle bar 44 for operating the waste disposal device 1 by rotation of the drum body 20 between the insertion position and the transit position.

In addition to the perspective view of the waste disposal device 1 as shown in FIG. 3, FIG. 3 further shows a cross section of the waste disposal device 1 in the transit position, i.e., wherein the opening 24 of the transport container 22 is aligned with the drum opening 14 to deposit the refuse (not shown) into the container 50. It is noted that typically a plastic bag (not shown) may be used as a liner to avoid contamination of the inner surface of the container 50. Again, the rotation means 26 are shown as well as the flexible sealing member 30 and the closing means 5 for substantially closing the container opening. Also the cover 40 comprising the cover opening 42 are shown. In addition, the locking means 56 for reversibly locking the two circumferential wall portions 52, 54 relative to each other in the telescopically extended position are shown in FIG. 3. Here, the locking means 56 are comprised of cooperating flanges that interact by rotating the two circumferential wall portions 52, 54 relative to each other.

FIG. 4 discloses a cross section of a further embodiment of the waste disposal device 1 of the present invention. In the waste disposal device 1 shown in FIG. 4 the drum body 20 is of cylindrical shape. The waste disposal device 1 shown in FIG. 4 is in its insertion position wherein the opening 24 of the transport container 22 is in alignment with the cover opening 42 provided in the cover 40. The cover 40 encloses the closing means 5 comprising the drum housing 10 and the drum body 20. The drum housing 10 comprises a drum opening 14 facing the container 50. A flexible sealing member 30 is provided about the edge of the drum opening 14. As noted, the flexible sealing member 30 comprises a first flexible sealing part 30′ and a separate second flexible sealing part 30″.

FIG. 5 shows a perspective cross sectional view of the waste disposal device 1 of the present invention, similar to the waste disposal device 1 shown in FIG. 4. Corresponding parts of the waste disposal device 1 are identified. The lefthanded waste disposal device 1 is in its insertion position, whereas the righthanded waste disposal device 1 is in its transit position.

FIG. 6 shows an exploded view of a drum body 20 having a pill-shaped shape. The drum body 20 is provide with a drum opening 24 for receiving refuse. A cooperating flexible sealing member 30 is also shown in FIG. 6. The flexible sealing member 30 is designed such that it encloses a drum opening (not shown) by providing a circumferential flexible sealing member 30.

FIG. 7 shows an exploded view of a drum body 20 having a cylindrical shape. The drum body 20 is provide with a drum opening 24 for receiving refuse. The drum body 20 is sealed by using two separate flexible sealing parts 30′, 30″. In addition to the two separate flexible sealing parts 30′, 30″, the drum body 20 is further sealed by providing sealing rings 38 on the circular bases of the cylindrical drum body 20.

1. A waste disposal device for refuse, in particular for personal hygiene materials and products, comprising a container having a bottom and a circumferential wall, wherein the container has a container opening on the end remote from the bottom,
wherein the waste disposal device is provided with closing means that are positioned near to the container opening for substantially closing the container opening in such a way that odour release is prevented, wherein the closing means comprise:
a drum housing provided in the internal part of the waste disposal device, said drum housing having a drum opening facing the interior of the container;
a drum body having an external surface that is at least partially closely connected to an inner surface of the drum housing, wherein the drum body has a transport container for the refuse, said transport container extending inwardly from the external surface thereof, wherein the drum body is pivotable between:
an insertion position wherein refuse is placeable in the transport container; and
a transit position wherein the transport container is aligned with the drum opening;
a flexible sealing member extending about the edge of the drum opening of the drum housing for that part that is closely connected to the external surface of the drum body, wherein:
the flexible sealing member comprises a connection part that is located outwards, and that is connected to the drum housing;
the flexible sealing member comprises a sealing part connected to the connection part, which sealing part extends inward from the connection part and which may be brought into sealing contact with the external surface of the drum body for sealing the container opening in a substantially odour-free manner; and
the inner end of the sealing part that is remote from the connection part is free from any connection to the drum housing such that a freely movable free end of the flexible sealing member is formed,
wherein the waste disposal device further comprises a cover configured and arranged to be received on the container, wherein the cover comprises a cover opening for supplying the refuse to the container, wherein the drum housing, when the cover is placed on the container, at least partially encloses the drum body, and wherein, in the insertion position, the transport container is aligned with the cover opening,
characterized in that
the sealing part of the flexible sealing member is provided with two or more upwardly facing raised sealing portions in a direction away from the bottom of the container, that are in contact with the external surface of the drum body; or
in case the drum body has a cylindrical shape comprising two parallel circular bases joined by a curved surface which curved surface defines the external surface of the drum body, the flexible sealing member optionally comprises two separated flexible sealing parts, in that one flexible sealing part extends about the edge of the drum opening of the drum housing opposite the edge of the drum opening of the drum housing the other flexible sealing part extends, and in that said flexible sealing parts are in contact with the external surface of the drum body.

2. The waste disposal device according to claim 1, wherein the flexible sealing parts are provided with two or more upwardly facing raised sealing portions in a direction away from the bottom of the container, that are in contact with the external surface of the drum body.

3. The waste disposal device according to claim 1, wherein, in case the drum body has a cylindrical shape, the two parallel circular bases of the drum body are connected to the drum housing and wherein each of the external surfaces of the two parallel circular bases is provided with a sealing ring for sealing a gap formed between the external surface of the circular base and the internal surface of the drum housing.

4. The waste disposal device according to claim 1, wherein the upwardly facing raised sealing portions of the sealing part of the flexible sealing member are selected from the group consisting of ridges, ribbons, strips and combinations thereof.

5. The waste disposal device according to claim 1, wherein the sealing part of the flexible sealing member has a sine waveform, triangle waveform, sawtooth waveform or composite waveforms combining different waveforms.

6. The waste disposal device according to claim 1, wherein the inner end of the flexible sealing member extends upwardly in a direction away from the bottom of the container, and is in contact with the outer surface of the drum body.

7. The waste disposal device according to claim 1, wherein the connection part is movably connected to the drum housing.

8. The waste disposal device according to claim 1, wherein the connection part is slidably received in a groove of the drum housing.

9. The waste disposal device according to claim 1, wherein the connection part is an integral part of the drum housing.

10. The waste disposal device according to claim 1, wherein the sealing part extends radially inward from the connection part, towards the bottom of the container, wherein the sealing part subsequently continues to extend further radially inward, in a direction away from the bottom of the container.

11. The waste disposal device according to claim 1, wherein the drum body is slidably connected to the drum housing, in such a way that in the insertion position the drum body is pressed, under the influence of gravity, on the flexible sealing member.

12. The waste disposal device according to claim 1, wherein the waste disposal device further comprises bag holder means for aligning a bag-like container with the drum opening.

13. The waste disposal device according to claim 12, wherein the bag holder means comprise a holder housing having a holder opening, wherein said holder housing is connected to the container, and wherein said holder opening is aligned with the drum opening.

14. The waste disposal device according to claim 13, wherein the drum opening comprises a wall that extends from the drum opening towards the bottom of the container, wherein said wall engages the edge of the holder that is formed by the opening of the holder.

15. The waste disposal device according to claim 1, wherein the circumferential wall of the container comprises at least two circumferential wall portions, which circumferential wall portions are configured such that they are telescopically slidable over each other.

16. The waste disposal device according to claim 14, wherein the at least two circumferential wall portions are moveable between a telescopically retracted position and a telescopically extended position, wherein, optionally, in the telescopically extended position the at least two circumferential wall portions are reversibly lockable relative to each other.
